(19) United States
(12) Patent Application Publication
(10) Pub. No.: US 2026/0298426 A1
(43) Pub. Date: Oct. 1, 2026

(54) Nightlight with Adjustable Light Source and/or Novel Lens

(71) Applicant: Mary Elle Fashions, Inc., St. Louis, MO (US)

(72) Inventors: Kenneth A. Howard, Creve Coeur, MO (US); Matthew S. Smith, St. Charles, MO (US)

(21) Appl. No.: 19/572,878

(22) Filed: Mar. 20, 2026

Related U.S. Application Data
(60) Provisional application No. 63/780,472, filed on Mar. 31, 2025.

(51) Int. Cl. F21S 8/00; F21Y 113/13

(52) U.S. Cl. CPC F21S 8/035; F21Y 2113/13

(57) ABSTRACT

A nightlight including a base and electrical prong adapted to be inserted into an electrical outlet are disclosed. The electrical prong is secured by and projects from the base. The nightlight also includes a main circuit electrically coupled to the electrical prong and secured by the base. A subassembly may be provided and may be pivotally attached to the base. The nightlight may further include a light source secured by the subassembly and electrically coupled to the main circuit for receiving an electrical current to power the light source so that the light source produces light. A lens is positioned adjacent to the base such that at least some of the light produced by the light source passes through the lens. The base may be manufactured from clear plastic whereby the internal circuit components such as switch components and circuit boards may be visible to the user. The light source may be a single color or a combination of red, green and blue light sources, may provide a substantial ultraviolet output, or may be a laser diode. The base of the nightlight may be internally illuminated with a second light source of the same or a different color than the main light source. The lens may be a traditional lens or may be tinted with a color. The lens may include a hologram pyramid and the light source may include a hologram projector. The lens may include a dichroic material, a polarizer, and/or a fluorescent pigment.

### FIELD OF THE INVENTION

The present disclosure relates to a nightlight for illuminating an area adjacent thereto and/or with a lens having unique visual properties.

### BACKGROUND OF THE INVENTION

Traditional nightlights have used low power light sources such as incandescent bulbs or LEDs to provide a low level of typically yellow or white light adjacent thereto. The position of the light source has generally been fixed relative to the body of the nightlight. Some nightlights have incorporated colored lights to display or illuminate with various selected colors. Nightlights may be activated with a manual switch or a light sensitive switch that is activated when the ambient light level falls below a preset level.

### SUMMARY OF THE INVENTION

A nightlight including a base and electrical prong adapted to be inserted into an electrical outlet are disclosed. The electrical prong is secured by and projects from the base. The nightlight also includes a main circuit electrically coupled to the electrical prong and secured by the base. An optional subassembly may be provided and may be pivotally attached to the base. The nightlight may further include a light source secured by the base or subassembly and electrically coupled to the main circuit for receiving an electrical current to power the light source so that the light source produces light. A lens is positioned adjacent to the base such that at least some of the light produced by the light source passes through the lens. The base may be manufactured from clear plastic such that the internal circuit components such as switch components and circuit boards may be visible to the user. The light source may provide a single color or a combination of red, green and blue light sources, may provide a substantial ultraviolet output, or may be a laser diode. The base of the nightlight may be internally illuminated with a second light source of the same or a different color than the main light source. The lens may be a traditional lens or may be tinted with a color. The lens may be formed as a hologram pyramid and the light source as a hologram projector. The lens may include a dichroic material, a polarizer, and/or a fluorescent pigment.

Other features will be in part apparent and in part pointed out hereinafter.

### BRIEF DESCRIPTION OF THE DRAWINGS

FIG. 1 shows a nightlight containing a pivoting light source and novel lenses.

FIG. 2 shows a schematic diagram of circuitry to control a light source.

Corresponding reference characters indicate corresponding parts throughout the drawings.

### DETAILED DESCRIPTION OF THE INVENTION

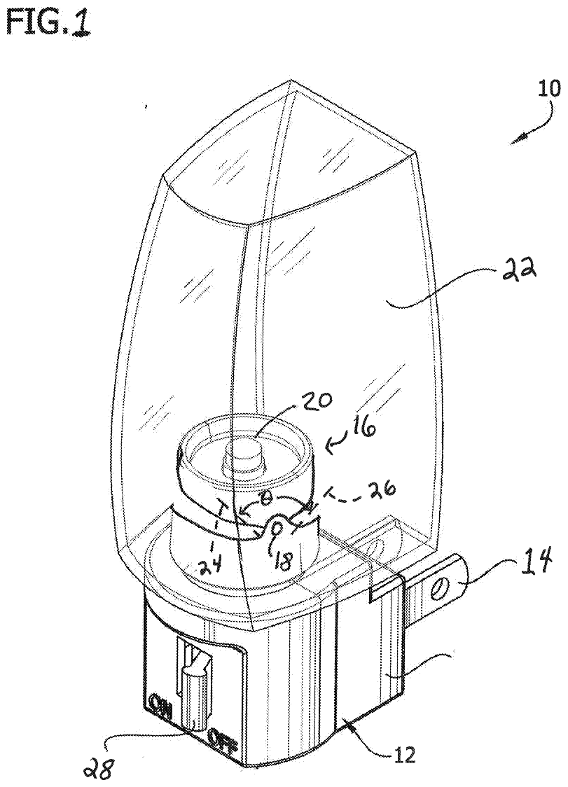

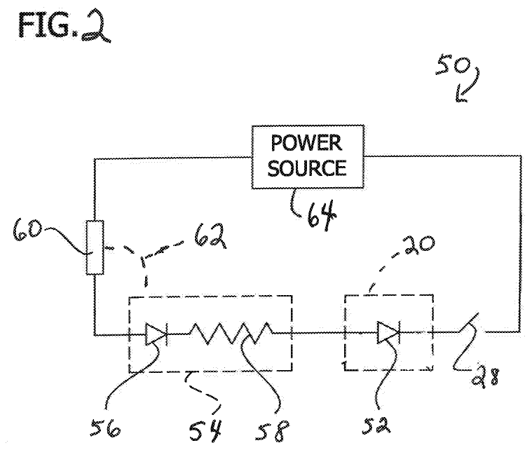

FIG. 1 shows a nightlight 10 that includes a base 12 that supports conventional electrical prongs 14 sized for insertion into a standard electrical outlet that provides nominal 120 volt AC electricity. The electrical prongs 14 are secured by and project from the base 12. A main circuit 54/60 (comprising a driver circuit 54 and/or a control circuit 60) shown in circuitry 50 of FIG. 2 is electrically coupled to the electrical prongs 14. The main circuit 54/60 is secured by the base 12 or a subassembly 16. A power source 64 shown in FIG. 2 may be a standard electrical outlet that provides nominal 120 volt AC electricity for connection to the electrical prongs 14 (not shown in FIG. 2).

The subassembly 16 is pivotally attached to the base 12 via a pivot 18. A light source 20 is secured by the subassembly 16 and is electrically coupled to the main circuit 54/60 via conductors (such as electrical wires, not shown) for receiving an electrical current to power the light source 20 so that the light source 20 produces light. A lens 22 is positioned adjacent to the base 12 and subassembly 16 such that at least some of the light produced by the light source 20 passes through the lens 22.

The subassembly 16 is configured to pivot via pivot 18 between a first arcuate endpoint 24 and a second arcuate endpoint 26. An angular distance Ø between the first arcuate endpoint 24 and the second arcuate endpoint 26 is at least 30 degrees and no more than 150 degrees. If preferred for illumination reasons or otherwise, the angular distance Ø between the first arcuate endpoint 24 and the second arcuate endpoint 26 is at 45 degrees and no more than 135 degrees. If preferred for illumination reasons or otherwise, the angular distance Ø between the first arcuate endpoint 24 and the second arcuate endpoint 26 is at least 60 degrees and no more than 120 degrees. As shown, the subassembly 16 is positioned in a “straight up” position meaning that the subassembly 16 is positioned at 90 degrees relative to a plane defined by a bottom surface of base 12.

It is noted that, when the subassembly 16 is pivoted to be closer to the first arcuate endpoint 24, then the light emitted by the light source 20 is directed more completely into the ambient space in front of the nightlight 10 (from the perspective of the nightlight 10 being plugged into an outlet in a wall (not shown)). It is further noted that, when the subassembly 16 is pivoted to be closer to the second arcuate endpoint 26, then the light emitted by the light source 20 is directed more completely to the structure behind the nightlight 10 (from the perspective of the nightlight 10 being plugged into an outlet in a wall (not shown)) such as a wall (not shown).

For different lenses 22 that create various visual effects as described more fully below, the angular position of the subassembly 16 and thus of the light source 20 may be preferably selected to optimize the various visual effects.

The subassembly 16 may be in contact with the base 12 wherein friction between the subassembly 16 and the base 12 holds the subassembly 16 in an arcuate position where the subassembly 16 does not pivot relative to the base 12 unless the subassembly 16 is acted upon by an external force to cause the subassembly 16 to pivot to a different arcuate position relative to the base 12.

The subassembly 16 may be in contact with the base 12 wherein a notch (not shown) between the subassembly 16 and the base 12 holds the subassembly 16 in an arcuate position where the subassembly 16 does not pivot relative to the base 12 unless the subassembly 16 is acted upon by an external force to cause the subassembly 16 to pivot to a different arcuate position relative to the base 12.

The subassembly 16 may be in contact with the base 12 wherein a detent (not shown) between the subassembly 16 and the base 12 holds the subassembly 16 in an arcuate position where the subassembly 16 does not pivot relative to the base 12 unless the subassembly 16 is acted upon by an external force to cause the subassembly 16 to pivot to a different arcuate position relative to the base 12.

The nightlight 10 may include a power switch 28 for manually turning the light source 20 “ON” and “OFF.” Alternatively, the power switch 28 may take the form of a light sensitive switch, such as a photo diode (not shown), which turns the light source 20 “ON” when the ambient light is relatively dark and turns the light source 20 “OFF” when the ambient light is relatively lit.

FIG. 2 shows the power switch 28 controlling the main electrical power provided to the circuitry 50. As seen in FIG. 2, an optional driver circuit 54 includes a current limiting resistor 58 and a diode 56 to limit the current supplied to the light source 20. The lower the resistance of current limiting resistor 58, the higher the current supplied to light source 20 and vice versa. An optional control circuit 60 may take the form of an integrated circuit or discrete electrical components (or both) to control the driver circuit 54 via a control line 62. Alternatively, driver circuit 54 could be removed and the function of controlling the light source 20 would then be handled by the control circuit 60. As a further alternative, the control circuit 60 could be removed and the function of controlling the light source 20 would then be handled by the driver circuit 54.

Light source 20 is shown inside a dashed line in FIG. 2 to denote that it may include one or more light emitting diodes 52, laser diodes, or other light sources.

As examples, the light source 20 may include a light emitting diode 52. The light source 20 may include a red light emitting diode, a green light emitting diode and a blue light emitting diode (such individual diodes not shown); wherein the light source 20 produces light comprising a mixture of a light emitted by the red, green and blue light emitting diodes 52. The main circuit 54/60 connects the light source 20 to the electrical current to control the light source 20 so that the light source 20 produces light having a selective color corresponding to the mixture. The main circuit 54/60 may be configured to connect the light source 20 to the electrical current to control the light source 20 to cyclically produce a pattern of the selective colors in succession. The main circuit 54/60 may be configured to connect the light source 20 to the electrical current to control the light source 20 to randomly produce the selective colors in succession.

As seen, the main circuit 54/60 includes an electrical component, such as an electrical switch component or a circuit board (neither shown). The base 12 may be an injection molded clear plastic wherein the electrical component is positioned inside of the base 12 and visible through the injection molded clear plastic. The lens 22 and the base 12 may be manufactured as a single piece of clear plastic.

The main circuit 54/60 may include an RGB integrated circuit (not shown) to power the light source 20 to control the light source 20 to produce a preset visual effect. A second light source (not shown) may positioned inside the base 12 to illuminate the base 12, wherein the second light source is electrically coupled to the main circuit 54/60 for receiving a second electrical current to power the second light source so that the second light source produces light. The second light source may include a light emitting diode that emits light having a single color, for example the single color may be red, green, yellow or blue.

As a further example, the second light source may include a red light emitting diode, a green light emitting diode and a blue light emitting diode wherein the second light source produces light comprising a mixture of the light emitted by the red, green and blue light emitting diodes. The main circuit 54/60 may power the second light source with the second electrical current to control the second light source so that the second light source produces light having a selective wavelength corresponding to the mixture. The main circuit 54/60 may be configured to power the second light source to control the second light source to cyclically produce a pattern of the selective colors in succession. The main circuit 54/60 may be configured to power the second light source to control the second light source to randomly produce the selective colors in succession.

The main circuit 54/60 may include an RGB integrated circuit to power the second light source to control the second light source to produce a preset or a customizable visual effect. The second light source may be positioned to produce light in a direction distal to the light source. The second light source may be positioned to produce light in a direction generally parallel to the electrical prong. The second light source may include a neon light emitting diode.

The second light source may also include a laser diode.

The main circuit 54/60 may be further configured to detect a short circuit or a low current level in the circuitry 50 and, in response thereto, the main circuit 54/60 may be configured to power the light source 20 or the second light source (not shown) to emit a flashing red light.

The lens 22 may be tinted with a red, green, blue, yellow, purple or pink tint. The base 12 may be tinted with a red, green, blue, yellow, purple or pink tint. A tinted coating may be used to cover the lens 22 and the base 12.

The lens 22 may include a dichroic material. The lens 22 may be covered with a dichroic film. The lens 22 may include a material that polarizes visible light, polarizes ultraviolet light, or polarizes both visible and ultraviolet light. The lens 22 may be covered with a material that polarizes visible light, polarizes ultraviolet light, or polarizes both visible and ultraviolet light.

The lens 22 may include a clear plastic impregnated with a fluorescent pigment that fluoresces in response to being illuminated with an ultraviolet light. The light source 20 may include a UV light source that produces a visible light and an ultraviolet light; and wherein the fluorescent pigment in the lens 22 fluoresces in response to being illuminated by the light produced by the UV light source.

The lens 22 may be covered with a film impregnated with a fluorescent pigment that fluoresces in response to being illuminated with an ultraviolet light. The light source 20 may include a UV light source that produces a visible light and an ultraviolet light; and wherein the fluorescent pigment in the film fluoresces in response to being illuminated by the light produced by the UV light source.

The lens 22 may include a hologram pyramid (not shown) wherein the light source 20 includes a hologram projector. The main circuit 54/60 provides the electrical current to the hologram projector and controls the hologram projector to produce light projected onto the hologram pyramid to display a hologram image.

The power output of the light source 20 may be 10% to 50% ultraviolet light. The power output of the light source 20 may be 20% to 50% ultraviolet light. The power output of the light source 20 may be 25% to 60% ultraviolet light. The power output of the light source 20 may be 35% to 50% ultraviolet light. The light source 20 may produce ultraviolet light having a wavelength from 395 nm to 405 nm. The light source 20 may produce ultraviolet light having a wavelength from 375 nm to 425 nm.

As seen, an invention may be practiced with a nightlight (not shown) where there is no subassembly 16 and no pivoting of the subassembly 16 nor pivoting of the light source 20, but where other novel features are implemented concerning the lens 22 and related visual effects.

Having described the invention in detail, it will be apparent that modifications and variations are possible without departing from the scope of the invention defined in the appended claims.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

1. A nightlight comprising:
a base;
an electrical prong adapted to be inserted into an electrical outlet, wherein the electrical prong is secured by and projects from the base;
a main circuit electrically coupled to the electrical prong;
a subassembly pivotally attached to the base;
wherein the base or the subassembly secures the main circuit;
a light source secured by the subassembly and electrically coupled to the main circuit for receiving an electrical current to power the light source so that the light source produces light;
a lens positioned adjacent to the base such that at least some of the light produced by the light source passes through the lens.

2. (canceled)

3. The nightlight of claim 1 wherein the subassembly is in contact with the base and wherein friction between the subassembly and the base holds the subassembly in an arcuate position where the subassembly does not pivot relative to the base unless the subassembly is acted upon by an external force to cause the subassembly to pivot to a different arcuate position relative to the base.

4. (canceled)

5. The nightlight of claim 1 wherein a detent holds the subassembly in an arcuate position where the subassembly does not pivot relative to the base unless the subassembly is acted upon by an external force to cause the subassembly to pivot to a different arcuate position relative to the base.

6. The nightlight of claim 1:
wherein the main circuit further comprises an electrical component;
wherein the base further comprises an injection molded clear plastic; and
wherein the electrical component is positioned inside of the base and visible through the injection molded clear plastic.

7. (canceled)

8. The nightlight of claim 1, wherein the light source comprises a light emitting diode.

9. The nightlight of claim 1,
wherein the light source comprises a red light emitting diode, a green light emitting diode and a blue light emitting diode;
wherein the light source produces light comprising a mixture of a light emitted by the red, green and blue light emitting diodes; and
wherein the main circuit further comprises an RGB integrated circuit to power the light source to control the light source to produce a preset or customizable visual effect light

10.-12. (canceled)

13. The nightlight of claim 1 further comprising a second light source positioned inside the base to illuminate the base, wherein the second light source is electrically coupled to the main circuit for receiving a second electrical current to power the second light source so that the second light source produces light.

14.-15. (canceled)

16. The nightlight of claim 13:
wherein the second light source comprises a red light emitting diode, a green light emitting diode and a blue light emitting diode;
wherein the second light source produces light comprising a mixture of a light emitted by the red, green and blue light emitting diodes; and
wherein the main circuit powers the second light source with the second electrical current to control the second light source so that the second light source produces light having a selective wavelength corresponding to the mixture.

17.-18. (canceled)

19. The nightlight of claim 16 wherein the main circuit further comprises an RGB integrated circuit to power the second light source to control the second light source to produce a preset or a customizable visual effect.

20.-22. (canceled)

23. The nightlight of claim 1 wherein the main circuit is further configured to detect a short circuit or a low current level in the nightlight and, in response thereto, the main circuit is configured to power the light source to emit a flashing red light.

24. The nightlight of claim 1 wherein the lens is tinted with a red, green, blue, yellow, purple or pink tint and wherein the base is tinted with a red, green, blue, yellow, purple or pink tint.

25.-27. (canceled)

28. The nightlight of claim 1:
wherein the lens further comprises a hologram pyramid;
wherein the light source further comprises a hologram projector;
wherein the main circuit provides the electrical current to the hologram projector; and
wherein the main circuit controls the hologram projector to produce light projected onto the hologram pyramid to display a hologram image.

29. The nightlight of claim 1 wherein the lens further comprises a dichroic material.

30. (canceled)

31. The nightlight of claim 1 wherein the lens further comprises a material that polarizes visible light, polarizes ultraviolet light, or polarizes both visible and ultraviolet light.

32. (canceled)

33. The nightlight of claim 1, further comprising:
a fluorescent pigment that fluoresces in response to being illuminated with an ultraviolet light;
wherein the lens further comprises a clear plastic impregnated with the fluorescent pigment;
wherein the light source further comprises a UV light source that produces a visible light and an ultraviolet light; and
where the fluorescent pigment in the lens fluoresces in response to being illuminated by the light produced by the UV light source.

34. The nightlight of claim 1, wherein the light source further comprises a UV light source that produces a visible light and an ultraviolet light.

35. The nightlight of claim 34 wherein a power output of the light source comprises 10% to 50% ultraviolet light.

36.-39. (canceled)

40. The nightlight of claim 34 wherein the UV light source produces the ultraviolet light having a wavelength from 375 nm to 425 nm.

41. The nightlight of claim 13, wherein the light source further comprises a laser diode and wherein the second light source further comprises a laser diode.

42. (canceled)

43. The nightlight of claim 1, wherein the subassembly is configured to pivot between a first arcuate endpoint and a second arcuate endpoint and wherein an angular distance between the first and second arcuate endpoints is at least 45 degrees and no more than 135 degrees.

44. (canceled)
